(19) United States
(12) Patent Application Publication
(10) Pub. No.: US 2018/0290515 A1
(43) Pub. Date: Oct. 11, 2018

(54) MULTI-LAYER BLOW MOLDED EXTRUSION

(71) Applicant: Ford Motor Company, Dearborn, MI (US)

(72) Inventors: Bernard Gerard MARCHETTI, Rochester Hills, MI (US); Charles Alan ROCCO, Milford, MI (US); Dan G. BUSUIOC, Dearborn, MI (US); Timothy R. BEARD, Perry, MI (US)

(21) Appl. No.: 15/484,832

(22) Filed: Apr. 11, 2017

(51) Int. Cl. B60H 1/00; B29C 49/04; B29C 49/22; B29C 49/48; B32B 27/08; B32B 27/20; B32B 27/34

(52) U.S. Cl. CPC B60H 1/00564; B29C 49/04; B29C 49/22; B29C 49/482; B29K 2077/00; B32B 27/20; B32B 27/34; B29B 2911/14166; B32B 27/08

(57) ABSTRACT

Blow molded components and systems and methods for forming the same are disclosed. The blow molded component may be an air duct, for example, a structural air duct. The structural air duct may include a hollow main body including a first layer of a first material and a second layer of a second material surrounding the first layer. At least one hollow protrusion may extend from the hollow main body and may include proximal and distal portions. The proximal portion may include the first layer surrounded by the second layer and the distal portion may include only one of the first and second layers. The duct may be formed by blow molding a multi-material parison. The first and second materials may have different tensile moduli, and during the molding process the material with the higher modulus may tear and allow the lower modulus material to fill the protrusion.

### TECHNICAL FIELD

The present disclosure relates to multi-layer blow molded extrusions, for example, using two or more different materials.

### BACKGROUND

Blow molding is a manufacturing process that may be used to form hollow polymer components. There are three main types of blow molding: extrusion blow molding, injection blow molding, and injection stretch blow molding. In general, extrusion blow molding includes melting plastic and extruding the molten plastic into a hollow tube, which may be called a parison. The parison may then be closed in a cooled mold. Then, air may be introduced (e.g., blown) into the parison, causing it to inflate and take the shape of interior of the mold. The molded component may then be ejected.

### SUMMARY

In at least one embodiment, a structural component is provided. The component may include a hollow main body including a first layer and a second layer surrounding the first layer, the second layer having a higher tensile modulus than the first layer. At least one hollow protrusion may extend from the hollow main body and include proximal and distal portions. The proximal portion may include the first layer surrounded by the second layer and the distal portion may include only the first layer.

In one embodiment, the structural component is an air duct and the at least one hollow protrusion is configured to communicate with ducts in a passenger compartment of a vehicle. In another embodiment, the second layer has a tensile modulus that is at least 100% greater than the first layer. The first layer may have a higher elongation at break than the second layer. In one embodiment, the first layer has an elongation at break that is at least 100% greater than the second layer. The distal portion may include only the first layer. The first layer may extend through an opening in the second layer. The distal portion may define an opening that is in fluid communication with the hollow main body.

In at least one embodiment, a method is provided. The method may include extruding concentric first and second materials to form a hollow, multi-layer parison; positioning the parison within a closed mold defining a mold cavity having a main body and at least one protrusion extending thereform; and introducing pressurized air into an interior of the parison to expand the parison to fill the mold cavity. The first material may tear when expanding into the protrusion and the second material may fill the protrusion.

In one embodiment, the first material has a higher tensile modulus than the second material. The first material may be extruded around the second material to form the hollow, multi-layer parison. The second material may extend through the tear in the first material to fill the protrusion. In another embodiment, the second material is extruded around the first material to form the hollow, multi-layer parison. The second material may extend around the tear in the first material to fill the protrusion. In one embodiment, a distal portion of the protrusion may include only the second material. The method may further include trimming the distal portion to form an opening in the protrusion.

In at least one embodiment, a structural component is provided. The component may include a hollow main body including a first layer of a first material and a second layer of a second material surrounding the first layer. At least one hollow protrusion may extend from the hollow main body and include proximal and distal portions. The proximal portion may include the first layer surrounded by the second layer and the distal portion may include only one of the first and second layers.

In one embodiment, the second material has a higher tensile modulus than the first material and the distal portion includes only the first layer, the first layer extending through an opening in the second layer. In another embodiment, the first layer has a higher tensile modulus than the second layer and the distal portion includes only the second layer. The second layer may extend around an opening in the first layer.

### BRIEF DESCRIPTION OF THE DRAWINGS

FIG. 1 is a perspective view of a non-structural blow-molded HVAC air duct, according to an embodiment;

FIG. 2 is a perspective view of a multi-layer blow-molded HVAC air duct including a structural component, according to an embodiment;

FIG. 3A is a perspective view of a well-defined protrusion in a blow-molded HVAC air duct formed of a low tensile modulus and high elongation properties, according to an embodiment;

FIG. 3B is a perspective view of a poorly-defined protrusion in a blow-molded HVAC air duct formed of a high tensile modulus and low elongation properties, according to an embodiment;

FIG. 4A is a perspective view of a pair of well-defined protrusions in a blow-molded HVAC air duct formed of a low tensile modulus and high elongation properties, according to an embodiment;

FIG. 4B is a perspective view of a pair of poorly-defined protrusions in a blow-molded HVAC air duct formed of a high tensile modulus and low elongation properties, according to an embodiment;

FIG. 5 is a schematic diagram of a 3D extrusion blow molding system, according to an embodiment;

FIG. 6 is a schematic diagram of a 3D multi-layer extrusion blow molding system, according to an embodiment;

FIG. 7 is schematic cross-section of a multi-layer parison disposed within an open mold tool, according to an embodiment;

FIG. 8 is a schematic cross-section of the parison and mold tool of FIG. 9A with the mold tool in the closed position;

FIG. 9 is a schematic cross-section of a multi-layer blow molded extrusion, according to an embodiment;

FIGS. 10A and 10B are photographs of a well-defined and a poorly-defined protrusion, respectively, corresponding to the drawings of FIGS. 3A and 3B; and

FIGS. 11A and 11B are photographs of well-defined and a poorly-defined protrusions, respectively, corresponding to the drawings of FIGS. 4A and 4B.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Blow molding, for example, extrusion blow molding, may be used to create a variety of components. As described in the Background, extrusion blow molding generally includes melting plastic and extruding the molten plastic into a hollow tube, called a parison. The parison may then be closed in a cooled mold. Air may then be blown into the parison, causing it to inflate and take the shape of interior of the mold. Extrusion blow molding may be used to form components or parts for vehicles.

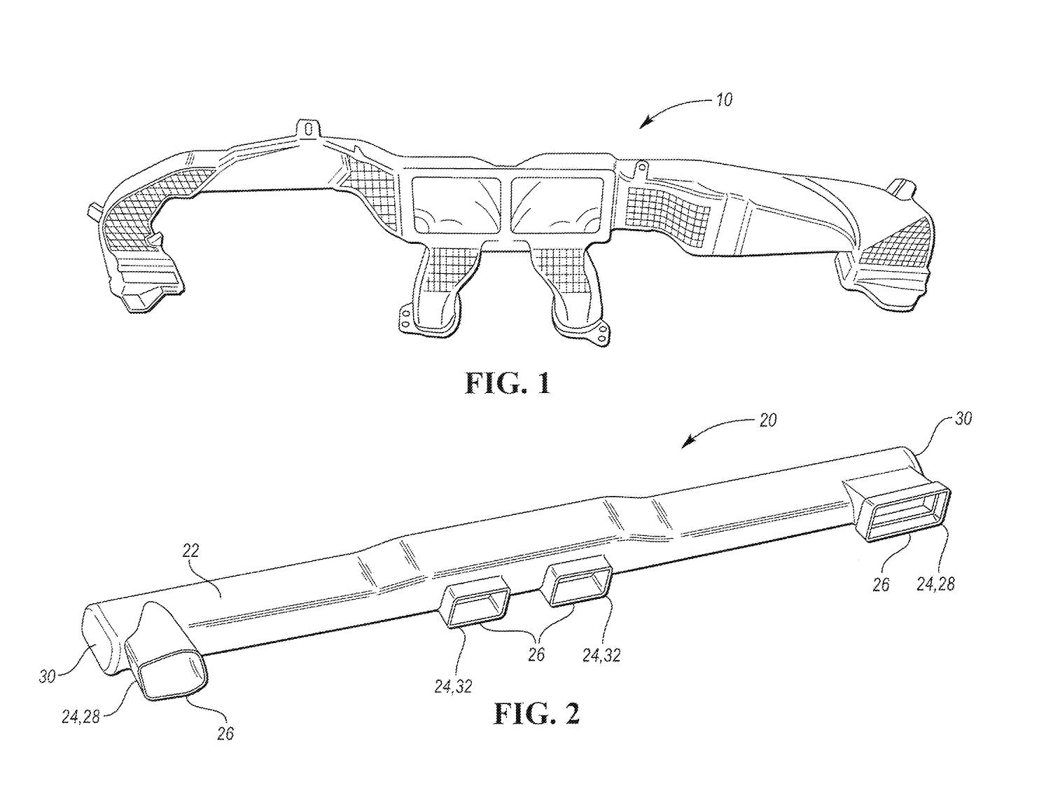

With reference to FIG. 1, an example of a blow molded heating, ventilation and air conditioning (HVAC) air duct 10 is shown. Existing blow molded HVAC air ducts are generally non-structural and their primary function is to carry air from the HVAC unit to the passenger compartment. Because there is little or no structural aspect to the air duct 10, it may be formed from a single material that has good stretch or elongation properties. These materials are often relatively low cost polymers, such as polyethylene or other polyolefins. In general, materials having high elongation have relatively low mechanical properties, such as tensile modulus. The relatively high elongation of the material allows the air duct to include a relatively complex shape having well-defined features. The elongation properties of the blow molding material make it able to stretch and fill the mold cavities, even those with sharp angles.

With reference to FIG. 2, an HVAC air duct 20 is shown that caries air from the HVAC unit to the passenger compartment, but that is also a structural component. For example, the air duct 20 may supplement or replace a cross car beam, typically made of steel. It may also provide additional features that support and/or enhance the instrument panel noise, vibration, and harshness (NVH). The air duct 20 may have a main body 22, which may provide the structural function of the air duct 20. The main body 22 may be configured to extend across the vehicle (e.g., perpendicular to the sides of the vehicle), similar to conventional cross bar beams. The main body 22 may have a hollow tubular shape. The term “tubular” is not intended to describe any particular cross-sectional shape of the main body 22. The cross-section of the main body may have any suitable shape, such as circular, elliptical, oval, rectangular, or irregular. As shown, the shape of the main body 22 may not be constant or identical along an entire length of the main body 22. However, in some embodiments, the cross-section may be substantially constant throughout.

The air duct may include one or more protrusion 24 extending from the main body 22. The protrusions 24 may form openings 26 that communicate with the ducts in the passenger compartment. The communication may be direct or through intermediate components. In the embodiment shown, the air duct 20 may include one or more end protrusions 28, which are located at or near the ends 30 of the main body 22. These protrusion(s) may communicate with ducts adjacent to the vehicle doors. As shown, there is one end protrusion 28 at each end 30 of the main body, however, there may be protrusion(s) 28 at only one end 30 or there may be multiple protrusions 28 at one or both ends 30.

There may also be one or more middle or central protrusions 32. The central protrusions may be in addition to, or instead of, the end protrusions 28. As used herein, middle/central may refer to a position away from the ends 30, for example, in the middle 75%, 50%, 33%, or 25% of the main body 22. These protrusion(s) may communicate with centrally located ducts, such as those included in or adjacent to the center console or entertainment/climate console. As shown, there are two central protrusions 32, however, there may be only a single central protrusion or three or more central protrusions. In the embodiment shown, the central protrusions 32 may be in close proximity to each other.

The end protrusions 28 and central protrusions 32 may define openings 26 that are configured to communicate with various ducts in the passenger compartment. The openings 26 may have any suitable shape. In the embodiment shown, the central protrusions 32 and one of the end protrusions 28 have a rectangular opening, while the remaining end protrusion 28 has an irregular shaped opening. However, each protrusion may have any suitable shape, such as rectangular, circular, elliptical, oval, irregular, or others. The ends 30 of the main body 22 may be closed, such that there is no air flow therethrough. The main body 22 may include an inlet (not shown) for receiving air from the HVAC unit. The inlet may be formed as one or more openings in the main body 22 or it may include one or more protrusions (e.g., similar to those protrusions 24).

In order to provide both air distribution and structural support functions, the air duct 20 may require both good mechanical properties (e.g., high tensile modulus) and good stretching properties (e.g., high elongation). As described above, these two characteristics are typically not available in a single material. To test the ability of a single material to form a structural member that also includes relatively precise features (e.g., the protrusions in air duct 20), air ducts similar to air duct 20 were blow molded from two different types of materials. The first material was a relatively low tensile modulus material and the second was a relatively high tensile modulus material. As described in greater detail below, the high modulus material was not able to form well-defined shapes. Accordingly, it may be difficult or impossible to form a structural air duct, such as air duct 20, using a single material.

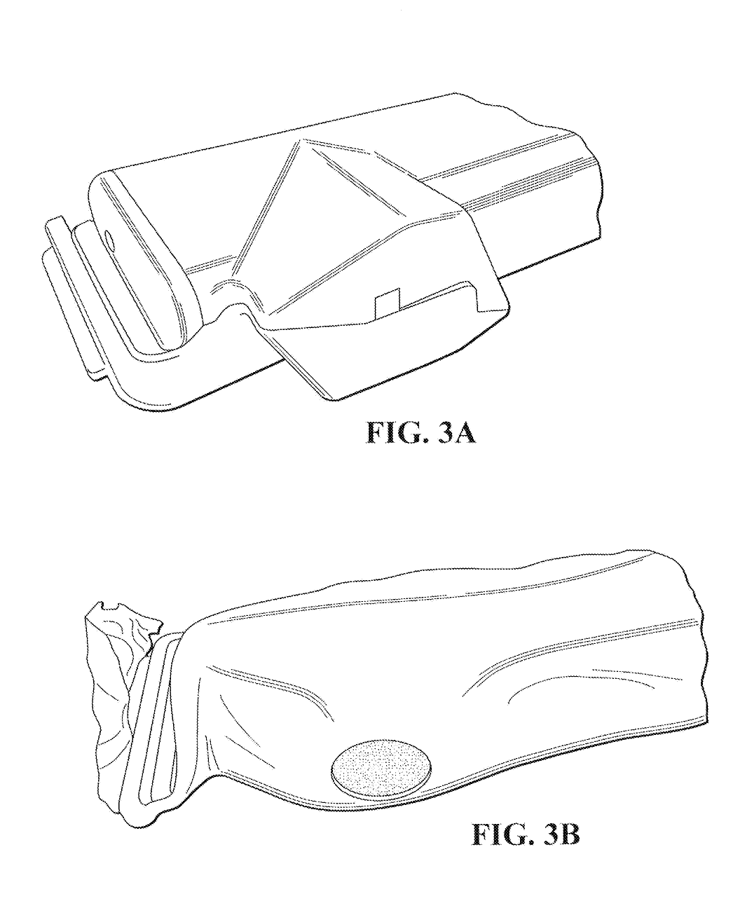

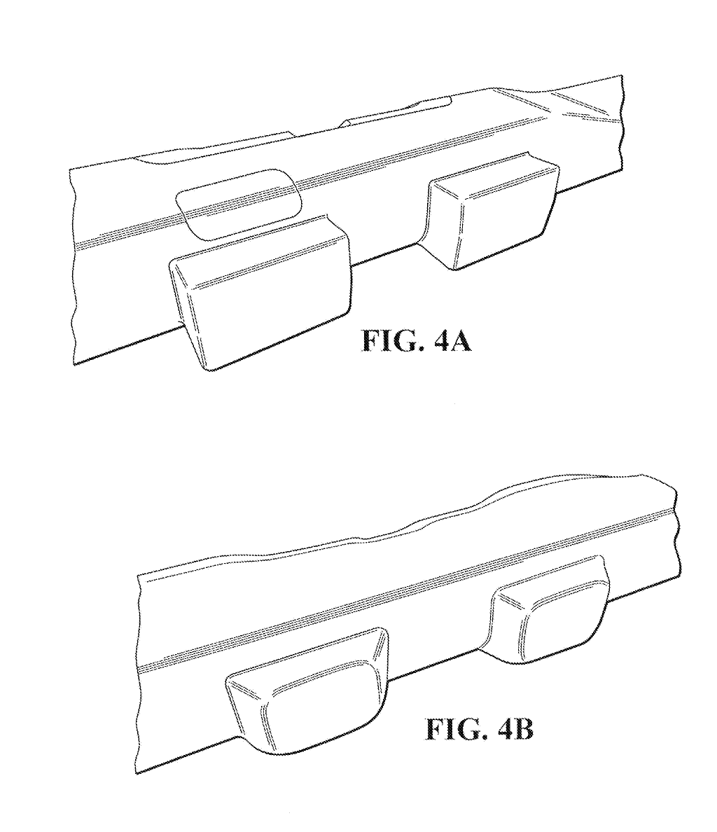

With reference to FIGS. 3A-4B, examples of blow-molded air ducts having a design similar to air duct 20 are shown. FIGS. 3A and 4A correspond to an air duct blow molded using a relatively low tensile modulus, high elongation material. In these examples, the material was a glass fiber reinforced polyamide composite that included 20 wt. % glass fiber. However, this particular polyamide composition (nylon) and weight percent glass fiber are merely one example and are not intended to be limiting. FIGS. 3B and 4B correspond to an air duct blow molded using a relatively high tensile modulus, low elongation material. In these examples, the material was a carbon fiber reinforced polyamide composite that included 40 wt. % carbon fiber. However, this particular polyamide composition (nylon) and weight percent carbon fiber are merely one example and are not intended to be limiting.

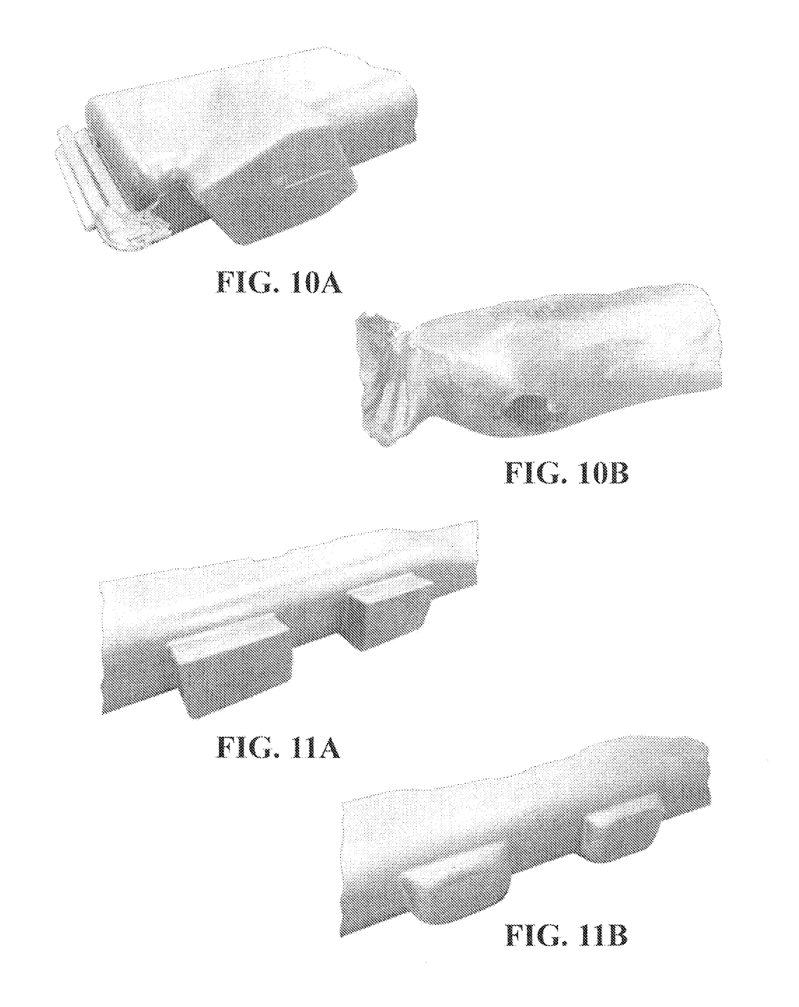

With reference to FIG. 3A, a protrusion is shown that is similar to the end protrusion(s) 28 of air duct 20. It can be seen that the relatively low tensile modulus glass fiber composite was able to stretch and completely fill the protrusion cavity of the blow mold. This resulted in a protrusion having a very well defined shape, including sharp corners (e.g., 90 degree corners). With reference to FIG. 3B, the same blow mold was used but with the relatively high tensile modulus carbon fiber composite. As shown, the carbon fiber composite was unable to stretch sufficiently to fill the mold cavity. As a result, the material ripped and a hole was created in the blown article. In addition, even if the material had not ripped, the high modulus material was not able to fully fill the cavity of the blow mold. Therefore, the protrusion has a poorly defined shape and no sharp features were formed. Photographs corresponding to the drawings in FIGS. 3A and 3B are shown in FIGS. 10A and 10B.

With reference to FIG. 4A, two protrusions are shown that are similar to the central protrusion(s) 32 of air duct 20. It can be seen that the relatively low tensile modulus glass fiber composite was able to stretch and completely fill the two protrusion cavities of the blow mold. This resulted in a protrusion having a very well defined shape, including sharp corners (e.g., 90 degree corners). With reference to FIG. 4B, the same blow mold was used but with the relatively high tensile modulus carbon fiber composite. As shown, the carbon fiber composite was unable to stretch sufficiently to fill the protrusion cavities of the mold. While the material did not rip for these protrusions, the high modulus material was not able to fully fill the protrusion cavities of the blow mold. Therefore, the protrusions both have a poorly defined shape and no sharp features were formed. Photographs corresponding to the drawings in FIGS. 4A and 4B are shown in FIGS. 11A and 11B.

As indicated in the Figures and description above, the high tensile modulus material by itself was not able to form a structural air duct having well-defined protrusions extending from a main body. The low tensile modulus material was able to form the desired shape, but does not have the mechanical properties to act as a structural component (e.g., that may replace a cross car beam). It has been discovered, however, that a combination of materials may be able to form an air duct that has sufficient mechanical properties to be a structural component, while also fulling filling one or more cavities of a blow mold to form well-defined protrusions and/or other sharp features.

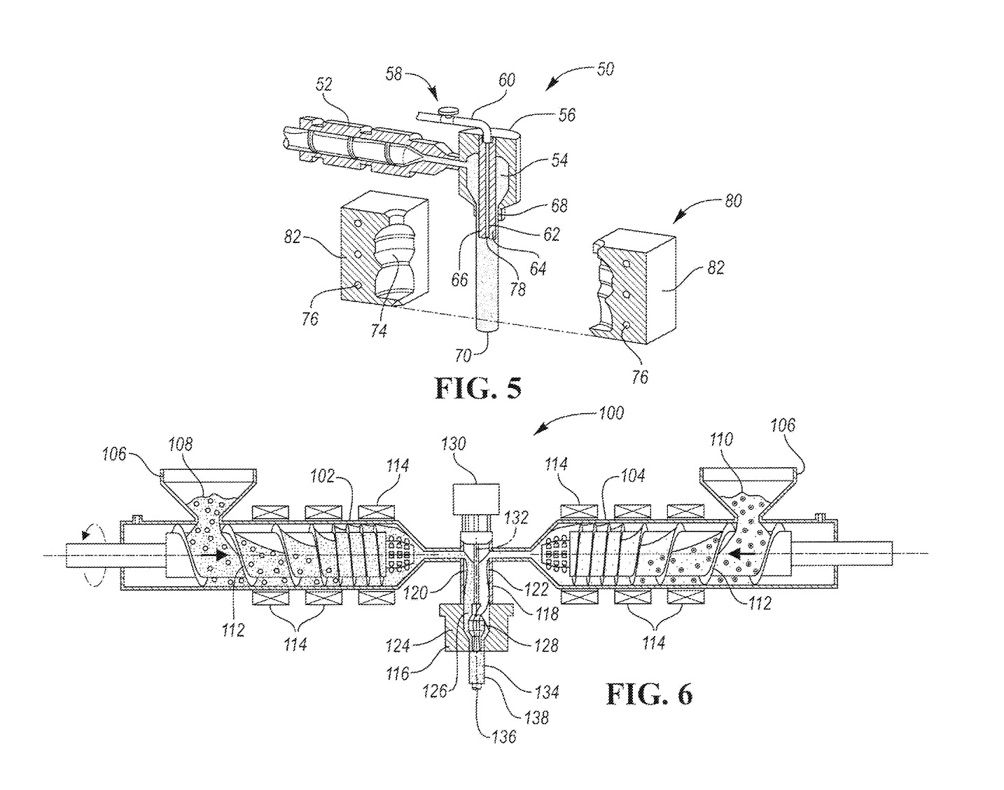

With reference to FIG. 5, a schematic diagram of a 3D blow molding system 50 is shown for forming blow molded components out of a single material. The system 50 may include screw and barrel assembly 52, which may be configured to receive a pre-compounded material or to compound two or more ingredients/components to form a compounded material. For example, the screw and barrel assembly 52 may be configured to receive pre-compounded pellets having a composition that is the same or similar to the desired final composition and to heat and shear them into a molten material 54. Alternatively, one or more polymer compositions may be introduced into the screw and barrel assembly along with a reinforcing fiber (e.g., glass or carbon) and/or other additives. These components may then be mixed together and heated/sheared to form the molten material 54. Such compounding steps are known in the art and will not be described in further detail.

The molten material 54 may be transferred to a die head 56, which may also be referred to as an extruder. An air system 58 may be at least partially incorporated into the die head 56. The air system may include an air hose 60 that may be at least partially external to the die head 56. The air hose 60 may transport air, such as pressurized air, to a blow pin 62. The blow pin 62 may be at least partially disposed within the die head 56. The blow pin 62 may have a cylindrical portion 64 that extends from within the die head 56 and out of the bottom of the die head 56. The external portion 66 of the cylindrical portion 64 may be referred to as the parison-forming portion. The molten material 54 may flow from a cavity within the die head 56 down and around the outside of the blow pin 62. An opening 68 in the bottom of the die head 56 may allow the molten material 54 to exit the die head 56, where it may flow down the external portion 66 of the blow pin 62. Once the molten material reaches the end of the external portion 66, it may continue to flow downward and may retain a hollow shape corresponding to the shape of the external portion 66. If the external portion 66 is cylindrical, as shown, then the molten material may have a substantially hollow cylindrical shape.

Once the molten material 54 flows past the end of the blow pin 62, it may be referred to as a parison 70. The parison 70 may continue to flow downward (e.g., due to gravity) until it extends past a bottom height of the mold 80, which may be in an open position. The mold 80 may have multiple parts. In the example shown, the mold 80 includes two halves 82, however, there may be three or more parts that cooperate together. The parts of the mold 80 may cooperate to form a mold cavity 74, which may correspond to the desired shape of the molded component. The mold parts may include cooling channels 76 therein, which may transport coolant (e.g., water) to and from the mold 80 to cool it.

In the embodiment shown, when the parison 70 has extended downward such that its distal end is at or below a bottom height of the mold 80, the mold halves 82 may close together to form the cavity 74. This may be referred to as open mold extrusion. In other embodiments, the mold halves 82 may already be closed prior to the parison 70 being extruded. This may be referred to as closed mold extrusion. After the mold 80 has been closed (or as it is closing), air may be delivered into the hollow interior of the parison 70. The air may be delivered through a channel or passage 78 in the blow pin 62. The air may be delivered under pressure (e.g., over ambient or atmospheric pressure). For example, the pre-blow pressure may be between 2 and 3 bar and the final pressure may be about 8 bar. However, these values are merely examples and are not intended to be limiting. The pressure from the air causes the parison to expand outward until it fills the cavity 74. If the mold 80 is actively cooled, the coolant may be circulated through the passage(s) to cool the mold and the blow molded polymer. Active cooling is not required. Instead, the mold may be passively cooled or uncooled. Once the newly formed component is cooled, the mold 80 may be opened and the component is ejected. The process may then be repeated to produce additional components.

With reference to FIG. 6, a schematic diagram of a 3D blow molding system 100 is shown for forming blow molded components out of multiple materials. In the embodiment shown, the system is configured to form a blow molded component out of two materials, however, the system may be configured to utilize 3, 4, or more materials. Based on the present disclosure, one of ordinary skill in the art will understand that modifications to the system 100 may be made to accommodate additional materials.

The system 100 may include components that are similar to those described with respect to system 50. However, modifications may be made to the system in order to incorporate two (or more) materials into the parison and, ultimately, the blow molded part. Individual components of the system 100 that are similar in form and function to system 50 may be described in reduced detail, and the description from system 50 may be applied. The system 100 may include two screw and barrel assemblies, a first screw and barrel assembly 102 and a second screw and barrel assembly 104. The screw and barrel assemblies may have any design known in the art, such as single screw, dual-screw, or others.

Each screw and barrel assembly may be configured to receive a pre-compounded material or to compound two or more ingredients/components to form a compounded material, as described above for screw and barrel assembly 52. In the embodiment shown, each screw and barrel assembly has a hopper 106 that is configured to receive a material to be extruded and feed it into the screw and barrel assembly. The material may be a pre-compounded material, such as pellets, that includes a base polymer and, optionally, one or more reinforcing materials or additives. In other embodiments, the material may include the base polymer and optional additives, but no reinforcing fibers. The fibers may be added in a separate step (e.g., downstream) or there may not be any reinforcing material.

In one embodiment, the first screw and barrel assembly 102 may be configured to receive and extrude a first material 108 and the second screw and barrel assembly 104 may be configured to receive and extrude a second material 110. The first material 108 may be a structural material having a high tensile modulus. In one embodiment, the first material 108 is a fiber reinforced composite including a base polymer and a plurality of reinforcing fibers. The fibers may be any type of reinforcing fiber having a higher tensile modulus than the base polymer, such as glass fibers, carbon fibers, aramid fibers, other fibers, or combinations thereof. If the first material 108 is a structural material, it may have a relatively high fiber content. In one embodiment, the first material 108 may have a fiber content of at least 20 wt. %, such as at least 30, 35, or 40 wt. %. For example, the first material 108 may have a fiber content of 10 to 60 wt. %, or any sub-range therein, such as 20 to 60 wt. %, 20 to 50 wt. %, 30 to 60 wt. %, 30 to 50 wt. %, 35 to 45 wt. %, or about 40 wt. % (e.g., ±5 wt. %). In one embodiment, the fiber type of the first material 108 may be predominantly (>50%) or completely (100%) carbon fiber.

The second material 110 may be an elastic material having high elongation properties. The second material 110 may include fiber reinforcement or it may be a non-reinforced material (e.g., no fibers or “neat”). In embodiments where the second material 110 includes reinforcing fiber, the fibers may be any type of reinforcing fiber having a higher tensile modulus than the base polymer, such as glass fibers, carbon fibers, aramid fibers, other fibers, or combinations thereof. If the second material 110 is an elastic material, it may have a relatively low fiber content or no fiber content. In one embodiment, the second material 110 may have a fiber content of at most 40 wt. %, such as at most 30, 20, 10, or 5 wt. %. For example, the second material 110 may have a fiber content of 0 to 40 wt. %, or any sub-range therein, such as 1 to 40 wt. %, 1 to 30 wt. %, 1 to 20 wt. %, 1 to 15 wt. %, 5 to 25 wt. %, 5 to 20 wt. %, 5 to 15 wt. %, or 5 to 10 wt. %. In one embodiment, the fiber type of the second material 110 may be predominantly (>50%) or completely (100%) glass fiber. In another embodiment, the fiber type of the second material 110 may not include carbon fiber.

The base polymers of the first and second materials may be the same or they may be different. The base polymer for each material may be any suitable polymer for forming a fiber reinforced polymer composite and/or a polymer that is blow-moldable. Non-limiting examples of suitable base polymers may include polyamides (e.g., nylons), polyolefins (e.g., polypropylene or polyethylene), ABS, PPS, PBT, PEEK, PEI, polysulfones, polycarbonates, PET, EVA, polyesters, phenolics, acetals, polystyrenes, PVC, other blow-moldable polymers. Particular non-limiting examples of polyamides may include PA6, PA66, of polyphthalamide (PPA). Particular non-limiting examples of polyolefins may include low density polyethylene (LDPE), medium density polyethylene (MDPE), high density polyethylene (HDPE), ethylene copolymers, such as ethylene vinyl acetate (EVA), and propylene copolymers. If the base polymers are different, the base polymer for the structural material may have a higher tensile modulus that the elongation material.

In embodiments where the first and second materials have different base polymers, a third or additional material may be included that provides a transition between the different base polymers and may allow materials that don't typically bond well to each other to be used together. This third material may be referred to as a tie layer, since it may tie together the different materials. The third material may have properties that are similar to the first material or the second material, or they may be intermediate. The third material may tear with the structural material or may expand with the elastic material (discussed in more detail, below). The third material may comprise a relatively small portion of the total parison material (e.g., <5 or 10 wt. %), since its primary purpose may be only to provide an interface between two dissimilar materials.

Accordingly, the first material 108 may be a structural material and the second material 110 may be an elastic material. The first material 108 may have a higher tensile modulus (e.g., Young's modulus or elastic modulus) than the second material 110. In one embodiment, the first material 108 may have a tensile modulus of at least 10 GPa, for example, at least 25 GPa, 50 GPa, 75 GPa, 100 GPa, or 150 GPa. In another embodiment, the second material 110 may have a tensile modulus of at most 25 GPa, for example at most 10 GPa, 5 GPa, 2 GPa, or 1 GPa. The tensile modulus of the first material 108 may be at least 50%, 100%, 200%, 500%, 750%, or 1,000% greater than that of the second material 110. In one embodiment, the tensile modulus of the first material 108 may be from 200 to 1,500% greater than the second material 110, for example, 250 to 1,250% or 400 to 1,000% greater.

The second material 110 may have higher elongation properties than the first material 108 (e.g., elongation at break, such as percent strain). In one embodiment, the elongation at break (e.g., tensile) of the first material 108 may be at most 5%, for example, at most 3% or at most 1%. In another embodiment, the elongation at break of the first material 108 may be from 0.1 to 5%, or any sub-range therein, such as 1 to 5% or 1 to 3%. In one embodiment, the elongation at break of the second material 110 may be at least 5%, for example, at least 7%, 10%, or 20%. In another embodiment, the elongation at break of the second material 110 may be from 10 to 150%, or any sub-range therein, such as 20 to 100%. The elongation at break of the second material 110 may be at least 50%, 100%, 200%, 500%, or 1,000% greater than that of the first material 108.

As described above, the first material 108 and the second material 110 may be introduced into the screw and barrel assemblies 102 and 104, respectively. They may be introduced in a fully formulated state (e.g., with the target composition) or may be compounded within the screw and barrel assembly. Each screw and barrel assembly may have one or more screws 112, which may rotate and shear, mix, and heat the material. The screw and barrel assemblies may also include one or more heaters 114 to provide supplemental heating to the material as it is extruded.

Once the materials 108 and 110 have been melted, they may be transferred to the die head 116 (also called an extruder). The die head 116 may include a multi-chambered vessel or tank 118 that may receive and keep separate the molten materials. The vessel 118 may have a first chamber 120 that is configured to receive the first material 108 in a molten state from the first screw and barrel assembly 102 and a second chamber 122 that is configured to receive the second material 110 in a molten state from the second screw and barrel assembly 104. While the vessel 118 is described as part of the die head 116, it may also be a separate component that is disposed intermediate the screw and barrel assemblies and the die head 116.

From the vessel 118, the molten materials 108 and 110 may be transferred into a body 124 of the die head 116. The body 124 may be similar to the die head 56 in the system 50. The body 124 may collect the materials 108 and 110 into separate cavities 126 and 128, respectively. Accordingly, the first and second materials 108 and 110 may still remain separated. An air system 130 may be included in the system 100, which may be similar to the air system 58 in the system 50. The air system 130 may include an air hose 132 that is connected to a source of air, such as pressurized air. In addition, the air system 130 may include a blow pin that extends within the die head 116 and extends outward therefrom. The blow pin is not shown in FIG. 6 because it is covered by the parison 134. However, similar to blow pin 62, it may have a hollow passage or channel therein and may have any suitable outer shape, such as a cylinder.

The die head 116 may be configured such that the molten first material 108 in cavity 126 and the molten second material 110 in cavity 128 may be dispensed from the die head to form a multi-material parison 134. The parison 134 may have a hollow shape that corresponds to the shape of the blow pin, such as a hollow cylinder. In the embodiment shown, the parison may have an inner layer 136 of the second material 110 and an outer layer 138 of the first material 108. However, in other embodiments, the layers may be reversed such that the first material 108 is on the inside and the second material 110 is on the outside. If the parison 134 is cylindrical, the inner and outer layers may be concentric. Once the parison 134 extends past the blow pin, the inner and outer layers may come in contact with each other. For example, an outer surface of the inner layer 136 and an inner surface of the outer layer 138 may form a continuous contact surface such that there is no gap between the inner and outer layers.

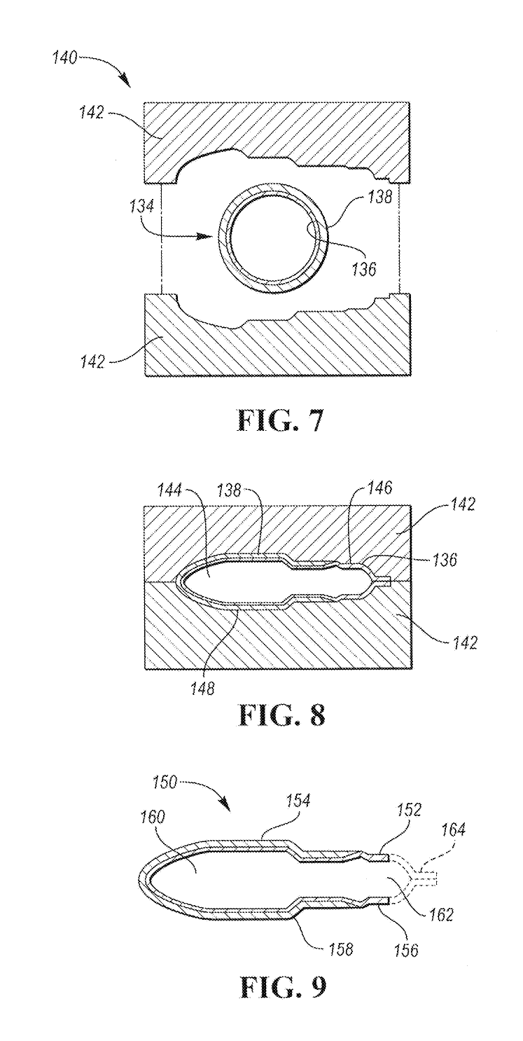

With reference to FIG. 7, a horizontal cross-section is shown of the parison 134 within two halves 142 of an open mold 140. The parison 134 may have extended downward from the die head 116 in FIG. 6, for example, by gravity. As shown, the multi-material parison 134 includes concentric layers—an inner layer 136 of the second material 110 and an outer layer 138 of the first material 108. As described above, the first material 108 may be a structural material and the second material 110 may be an elastic material.

With reference to FIG. 8, the halves 142 of the mold 140 have been closed and pressurized air has been introduced into the parison 134 by the blow pin to expand parison to the contours of the mold. When the mold 140 is closed, it forms a cavity 144. The mold 140 may be configured such that the cavity 144 defines a protrusion 146. The protrusion 146 may be a portion of the cavity 144 that extends away from a main body 148 of the cavity 144 and may include one or more regions that include sharp angles or corners. The protrusion 146 may be similar to those described above with respect to air duct 20 (e.g., end protrusions 28 and central protrusions 32). The cavity 144 of the mold 140 may include multiple protrusions 146 along its longitudinal axis (e.g., parallel to the parison).

As described above and shown in FIGS. 3A-4B, structural materials may not be capable of stretching and conforming to the mold cavity, particularly in regions with well-defined features or sharp corners. The structural material may rip in these regions and/or may fail to completely fill the mold. The disclosed system 100 accommodates the reduced elongation of the structural material while still providing a blow molded article that completely fills the mold and has well-defined features. As shown in FIG. 8, the outer layer 138 of the parison 134, the structural material in this embodiment, may split or tear in the region of the protrusion 146 during the blow molding process. However, the inner layer 136, the elastic material in this embodiment, may extend through the opening in the outer layer 138 and may continue to stretch and fill the mold cavity 144. As a result, the protrusion 146 may be completely filled and may have well-defined features due to the greater elongation of the elastic material. The structural material in the outer layer 138 may have sufficient elongation to conform to the mold 140 in the main body 148. Therefore, the main body 148, which may be similar to the main body 22 in air duct 20, may include a continuous and unbroken layer of the structural material. This may provide the finished article to have the high mechanical properties necessary to act as a structural component (e.g., replace/supplement a cross car beam), while also providing a well-defined shape in areas where mechanical properties are less critical (e.g., protrusions for communicating with air vents).

With reference to FIG. 9, a cross-section of a multi-material, blow-molded component 150 is shown after being ejected from a blow mold, such as mold 140. The cross-section shown is through a portion of the component 150 that includes a protrusion 152 extending from a main body 154. In one embodiment, the component 150 may be an air duct, similar to air duct 20. The component may have a longitudinal axis that extends into/out of the page. There may be additional protrusions 152 along the longitudinal axis, for example, like the end protrusions 28 and central protrusions 32 in air duct 20.

As described with respect to FIG. 8, the protrusion 152 in component 150 may include a region where the inner material 156 extends through a rip, tear, or opening in the outer material 158. The inner material, which may be a high-elongation material, may have expanded through the opening in the outer material 158 during the blow molding process to fill the mold cavity. In the embodiment shown, a portion of the protrusion 152 has been trimmed off to form an opening 162 in the protrusion 152 that communicates with a hollow passage 160 within the body 154. The trimmed portion 164 is shown in dashed lines. The protrusion 152 may be trimmed in a region where only the inner material 156 (e.g., the elastic material) is present. This may correspond to a region of the protrusion where high mechanical properties (e.g., tensile modulus) are less important than in the body 154. As described above, the body 154 may be a structural component, which may require relatively high mechanical properties. While the embodiment shown in FIG. 9 includes a trimmed portion, the component 150 may also be left intact after blow molding (minor trimming of excess material may be performed), such that the protrusion(s) 152 are substantially unchanged after ejection.

The 3D blow molding systems and methods disclosed above and shown in FIGS. 6-8 are described for a two-material system. However, more than two materials may be incorporated into the blow molding system, such as three, four, or more materials. For example, a three-material system may include a third screw and barrel assembly, which may be similar to the first and second screw and barrel assemblies in FIG. 6. The die head may be modified to receive and keep separate three different molten polymer materials and to form them into a three-layer parison. The parison may be similar to the two-layer parison shown in FIGS. 6 and 7, but with an additional layer (e.g., on the inside or the outside). The same approach may be used to add more layers in addition to three layers (e.g., a fourth screw and barrel assembly to form a four-layer parison).

If there are multiple materials, the ordering of the materials in the parison may be similar to the two-layer parison. For example, the material with the highest tensile modulus may be on the outside, a material with an intermediate modulus may be in the middle, and the material with the lowest modulus may be on the inside. Accordingly, during a blow molding operation, the outer layer (highest modulus) may tear first at a first elongation. The middle layer may then extend through the tear in the outer layer and then tear second at a second, greater elongation. The inner layer may then expand through the tears in both the middle and the outer layers to fill the mold cavity and provide the well-defined shape described above.

In another embodiment, the middle layer may not tear, and may also stretch to fill the cavity in a well-defined shape. Accordingly, the protrusion may have a dual-layer construction (middle layer and inner layer) that is well-defined. The middle layer may have properties that are intermediate to those of the inner and outer layers, for example, a tensile modulus and elongation at break that are between those of the inner and outer layers. This may be accomplished by using an intermediate fiber content between the two, by using a different fiber type or fiber blend, by using a different polymer base, or a combination thereof. The base polymer of the middle layer may be the same or different from the inner and/or outer material, and may be chosen from the group described with reference to the two-layer embodiments.

As described above, in embodiments where the first, second, and/or third materials have different base polymers, an additional material may be included that provides a transition between the different base polymers and may allow materials that don't typically bond well to each other to be used together. This additional material may be referred to as a tie layer or material, since it may tie together the different materials. The additional material may have properties that are similar to the first material, the second material, or the third material, or they may be intermediate. The additional material may tear with the structural material(s) or may expand with the elastic material(s).

In the 3D blow molding systems and methods disclosed above and shown in FIGS. 6-8, the layers are ordered such that the high modulus/low elongation material is the outer layer and the low modulus/high elongation material is the inner layer. When the outer layer rips/tears, the inner layer extends through the tear to fill the mold cavity and provide well-defined features. In other embodiments, the order may be reversed. The high modulus material may be on the inside layer of the parison and the low modulus material may be on the outside layer. During the blow molding operation, both layers may begin to expand, with the expansion of the outer layer (low modulus) limited by the expansion of the inner layer. When the inner layer (high modulus) stretches to its limit, it may tear, similar to above. The air pressure inside the parison may then directly act on the outer layer through the tear and cause the outer layer to expand and completely fill the mold cavity. The same ordering may be applied to parisons including three or more layers. For example, the material with the highest tensile modulus may be on the inside, a material with an intermediate modulus may be in the middle, and the material with the lowest modulus may be on the outside. In this example, the inner layer would tear first, then the middle layer, and then the outer layer would be expanded to fill the mold. Alternatively, the middle layer may not tear, and may also stretch to fill the cavity in a well-defined shape.

While the embodiments disclosed above have been described in the context of air ducts, one of ordinary skill in the art will understand that the same principles may be applied in other areas. The disclosed systems and methods may be used to form blow molded articles for use in any application. The articles may include multiple materials, such as two, three, or more materials, in order to take advantage of the properties of each type of material. Materials with high and low tensile moduli may be combined to form structural materials that also include well-defined shapes in areas where mechanical properties are less critical.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A structural component, comprising:
a hollow main body including a first layer and a second layer surrounding the first layer, the second layer having a higher tensile modulus than the first layer;
at least one hollow protrusion extending from the hollow main body and including proximal and distal portions; and
the proximal portion including the first layer surrounded by the second layer and the distal portion including only the first layer.

2. The component of claim 1, wherein the structural component is an air duct and the at least one hollow protrusion is configured to communicate with ducts in a passenger compartment of a vehicle.

3. The component of claim 1, wherein the second layer has a tensile modulus that is at least 100% greater than the first layer.

4. The component of claim 1, wherein the first layer has a higher elongation at break than the second layer.

5. The component of claim 4, wherein the first layer has an elongation at break that is at least 100% greater than the second layer.

6. The component of claim 1, wherein the distal portion includes only the first layer.

7. The component of claim 6, wherein the first layer extends through an opening in the second layer.

8. The component of claim 1, wherein the distal portion defines an opening that is in fluid communication with the hollow main body.

9. A method, comprising:
extruding concentric first and second materials to form a hollow, multi-layer parison;
positioning the parison within a closed mold defining a mold cavity having a main body and at least one protrusion extending thereform;
introducing pressurized air into an interior of the parison to expand the parison to fill the mold cavity; and
the first material tearing when expanding into the protrusion and the second material filling the protrusion.

10. The method of claim 9, wherein the first material has a higher tensile modulus than the second material.

11. The method of claim 10, wherein the first material is extruded around the second material to form the hollow, multi-layer parison.

12. The method of claim 11, wherein the second material extends through the tear in the first material to fill the protrusion.

13. The method of claim 10, wherein the second material is extruded around the first material to form the hollow, multi-layer parison.

14. The method of claim 13, wherein the second material extends around the tear in the first material to fill the protrusion.

15. The method of claim 9, wherein a distal portion of the protrusion includes only the second material.

16. The method of claim 15, further comprising trimming the distal portion to form an opening in the protrusion.

17. A structural component, comprising:
a hollow main body including a first layer of a first material and a second layer of a second material surrounding the first layer;
at least one hollow protrusion extending from the hollow main body and including proximal and distal portions; and
the proximal portion including the first layer surrounded by the second layer and the distal portion including only one of the first and second layers.

18. The component of claim 17, wherein the second material has a higher tensile modulus than the first material and the distal portion includes only the first layer, the first layer extending through an opening in the second layer.

19. The component of claim 17, wherein the first layer has a higher tensile modulus than the second layer and the distal portion includes only the second layer.

20. The component of claim 19, wherein the second layer extends around an opening in the first layer.
